(19) United States
(12) Patent Application Publication
(10) Pub. No.: US 2009/0217023 A1
(43) Pub. Date: Aug. 27, 2009

(54) Method for upgrading a microprocessor-controlled device with a new software code via a communication network

(75) Inventors: Reinhard Griech, Weil am Rhein (DE); Christian Seiler, Auggen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH + Co. KG, Maulburg (DE)

(21) Appl. No.: 11/918,574

(22) PCT Filed: Apr. 21, 2006
(86) PCT No.: PCT/EP2006/061732

§ 371 Date: Dec. 31, 2008

(30) Foreign Application Priority Data
Apr. 22, 2005 (DE) 102005018910.5

(51) Int. Cl. G06F 15/177; G06F 1/24; G06F 11/14

(52) U.S. Cl. 713/2; 713/100; 714/38; 717/168; 714/E11.142; 714/E11.133

(57) ABSTRACT

In a method for equipping a microprocessor-controlled device with new software code via a communication network, the device has a non-volatile program memory, with two memory areas, a first memory area and a second memory area. The first memory area (boot sector) is provided for a basic program, which provides a first operating system and first functionalities of the device, and the second memory area (update sector) is provided for the software code to be transferred. The first memory area is protected by hardware means against overwriting. The following method steps are performed. First, there is a system boot with the basic program from the first memory area. In such case, a system variable UPDATE is read. In case this has the value “perform update”, an invocation of a function “perform firmware update” occurs. Then this variable is set to the value “invalid firmware”. Next, a connection is established to a superordinated unit and the new software code is transferred into the device. Following storage of the new software code in the second memory area, a test of the new software code for bit error is performed. In case bit errors have occurred during the transfer, a new system boot is performed. If no bit errors have occurred, the new software code is executed from the second memory area and the system variable UPDATE is written with the value “valid firmware”. Through this method, a safe equipping of microprocessor-controlled devices with new software code via a communication network is possible.

The invention relates to a method for equipping a microprocessor-controlled device with new software code via a communication network.

As a rule, it is necessary in the case of microprocessor-controlled devices to adapt the software in the device from time to time. Thus, the device manufacturer is normally further developing the software continuously. The corresponding software-update can e.g. be transferred directly into the device at the device by a service technician. If problems occur in the transfer of the software-update into the device or during operation of the software update, then the service technician can normally eliminate such immediately on-site.

Frequently, microprocessor-controlled devices, such as those used e.g. in process automation technology, are connected via communication networks with superordinated units. This being the case, the software update can also be transferred via the communication network into the device.

An essential disadvantage, in such circumstances, is that the downloading of a software update into a device is a relatively critical procedure and problems during such are never completely out of the question. In extreme cases, such problems can lead to total shutdown of the device.

In this case, it is necessary that a service technician hunt out the device, in order to fix the problem on-site. If service-central and device are far removed from one another, this can be very time consuming.

If the relevant device is integrated with other devices in an automated process, failure of the device can even lead to shut down of an entire plant, an event that can certainly be associated with significant costs.

Especially in automation technology, microprocessor-controlled field devices are often used for registering and/or influencing process variables. Such field devices include, for example, fill level measuring devices, mass flow measuring devices, pressure and temperature measuring devices, pH and conductivity measuring devices, which, as sensors, register the corresponding process variables fill level, flow, e.g. flow rate, pressure, temperature, pH-value, and conductivity value, respectively.

Serving for influencing process variables are actuators, which, e.g. as valves, control the flow of a liquid in a section of pipeline, or as pumps, the fill level in a container.

Also referred to as field devices are recording devices, which log measured data on-site.

A large number of such field devices are manufactured and sold by the firm, Endress+Hauser.

As a rule, field devices in modern automation plants are connected via fieldbus systems (HART, Profibus, Foundation Fieldbus, etc.) with superordinated units (e.g. control systems or control units). These units serve for, among other things, process control, process visualization, process monitoring.

Most often, fieldbus systems are integrated into company networks. In this way, process and field device data can be accessed from different areas of an enterprise.

For worldwide communication, fieldbus systems can also be connected with public networks, e.g. the Internet. The Fieldgate product of the firm, Endress+Hauser, enables connecting of field devices with the Internet.

Also the software used in field devices is continuously being further developed. Consequently, equipping of these devices with new software code via a communication network can, from time to time, become necessary.

DE 100 84 648 discloses a method from the field of the invention, wherein software is transferred from a host-computer into a field device via a fieldbus as communication network. The field device has two memory areas for storing the new software (software-update).

The method of DE 100 84 648 is burdened by a number of disadvantages.

Thus, a plurality of memory areas are necessary, which all must be addressed by a microprocessor or microcontroller.

Selection of the two memory areas is accomplished via jump addresses for the new software, a fact that is disadvantageous, considering the complexity of the system.

The update procedure is controlled by a host-computer and does not occur self-sufficiently.

Replacement of the entire operating system is not considered.

A possible disturbance or system crash during the update procedure can lead to problems, when the new memory area is not yet activated.

EP-1108984 A1 discloses another method from the field of the invention. In this case, likewise two memory areas are available for storing the software update. Following transfer of the new software into the device, the memory area with the old software is deactivated and the memory area with the new software activated. If, during the switching of the memory areas, disturbances arise, which influence the ability of the new software to run, this can lead to a permanent system error, in the case of which the microprocessor system “remains hanging” in an undefined or unstable state, and the result of this can be a total shutdown of the device.

Such disturbances can only be limited in the field device with difficulty by supplemental measures. Moreover, in the case of this method, a voltage monitoring with power backup is necessary. If, e.g. during the switching of the memory areas, a voltage interruption of the supply voltage of the microprocessor system occurs, this can lead to a serious system error.

Since voltage losses during the update procedure can lead to errors in the software, normally additional hardware is necessary, e.g. complicated means for early recognition of voltage loss (pre-powerfail), coupled with power backup.

An object of the present invention, therefore, is to provide a simple method for equipping a micro processor-controlled device with new software code via a communication network, which method does not exhibit the aforementioned disadvantages, which, especially, avoids system errors leading to total shutdown of the device, and which is, at the same time, implementable without demanding undue resources and at favorable cost.

This object is achieved by the features given in claim 1, namely the method for equipping a microprocessor-controlled device with new software code via a communication network, wherein the device has a non-volatile program memory, with two memory areas, a first memory area and a second memory area,

wherein the first memory area (boot sector) is provided for a basic program which provides a first operating system and first functionalities of the device

and the second memory area (update sector) is provided for the software code to be transferred, and the first memory area is protected by hardware means against overwriting, comprising the following method steps:

A. Booting system with the basic program from the first memory area;
B. reading a system variable UPDATE;
C. if the system variable UPDATE has a value “perform update”, invoking a function “perform firmware update” with the following sub-steps:

1. Writing to the system variable UPDATE a value “invalid firmware”;

2. establishing a connection to a server, as superordinated unit, and transferring the new software code into the device;

3. storing the new software code in the second memory area;

4. testing the new software code for bit error;

5. in case a bit error has occurred, rebooting system according to step A);

6. in case no bit error has occurred, executing the new software from the second memory area;

7. writing to the system variable UPDATE a value “valid firmware”;

D. if the system variable UPDATE has the value “valid firmware”,
E. testing software of the second memory area for bit error;
F. if no bit error is present, executing the software of the second memory area;
G. if a bit error is present, writing to the system variable UPDATE a value “invalid firmware” and executing the basic program of the first memory area.

An essential idea of the invention is that the device always has software that is capable of running and with which the microprocessor system can be booted.

Even when external disturbances occur during the equipping, these cannot lead to an undefined or instable state of the system. There is always runnable software, the basic program, available.

With the help of the method of the invention, a safe equipping of a device with new software code from a remote location is possible. The new software code can also include the operating system or the entire firmware of the device.

Should a bit error occur in the software code during transfer via the communication network, per claim 2, a corresponding report is transmitted to the sender of the new software code, in order to initiate a renewed transferring of the software code via the communication network.

Advantageously, the non-volatile program memory has an address space, which is larger than that which can be managed by the microprocessor connected with the program memory. In this way, the address space of the microprocessor can be optimally used and the address space is not limited by the second memory area.

In a further development of the invention, the address space of the program memory is exactly twice as large as that which can be managed by the microprocessor.

A typical memory size for the program memory is 1064 kB.

Advantageously, the program memory has a switchable input controllable by the microprocessor for selecting between the two memory areas.

The invention will now be explained in greater detail on the basis of an example of an embodiment presented in the drawing, the figures of which show as follows:

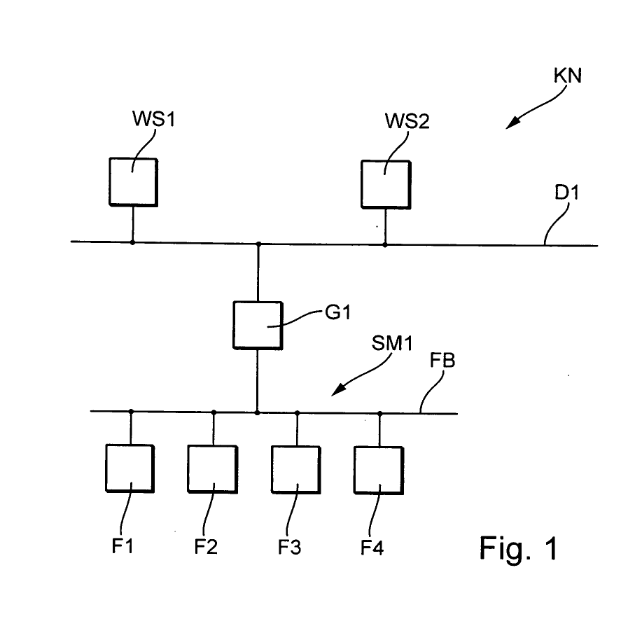

FIG. 1 schematic drawing of a communication network of automation technology;

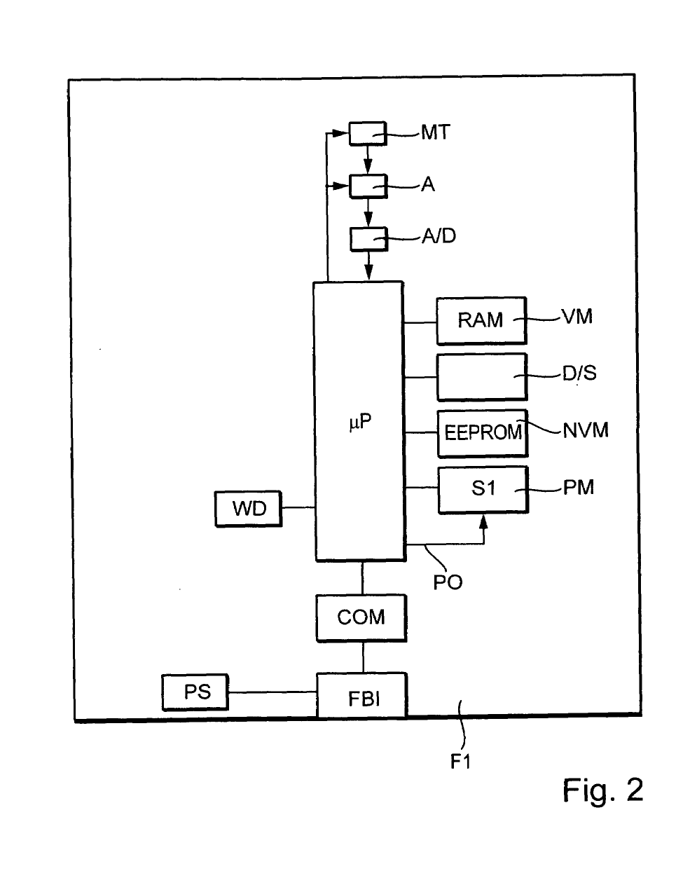

FIG. 2 block diagram of a field device;

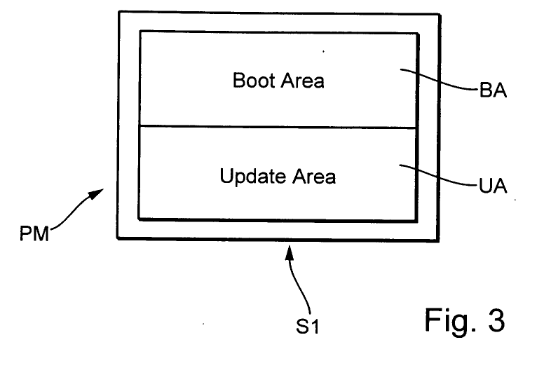

FIG. 3 field-device program-memory divided into two memory areas;

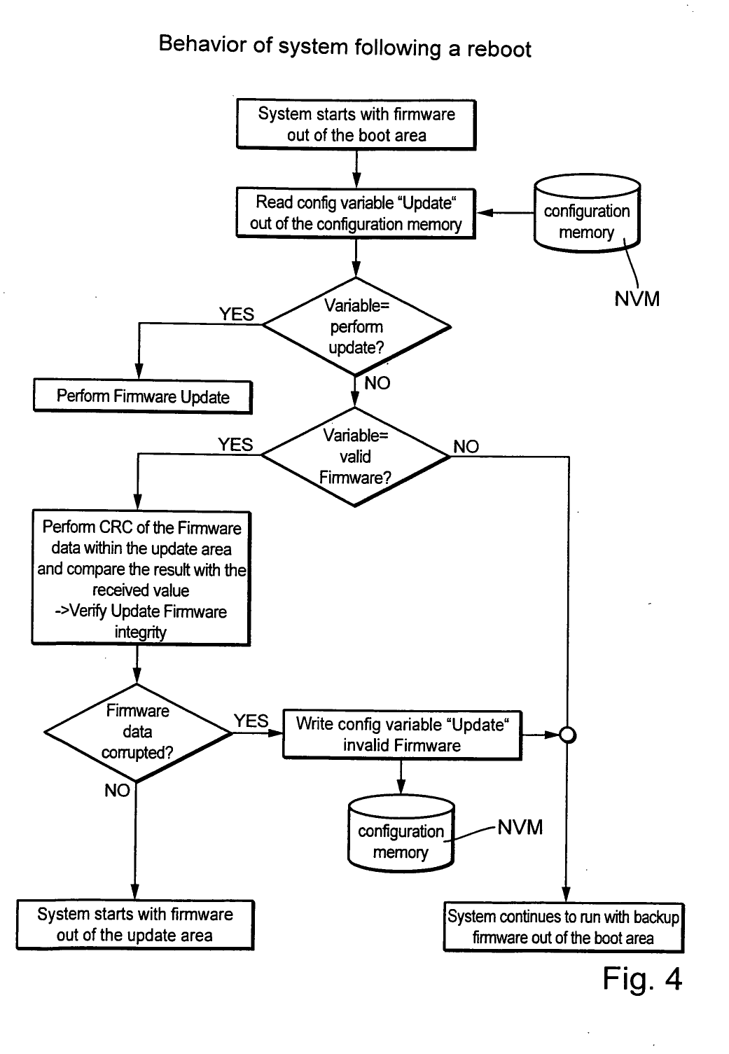

FIG. 4 flow diagram of the method of the invention, describing system behavior following system boot;

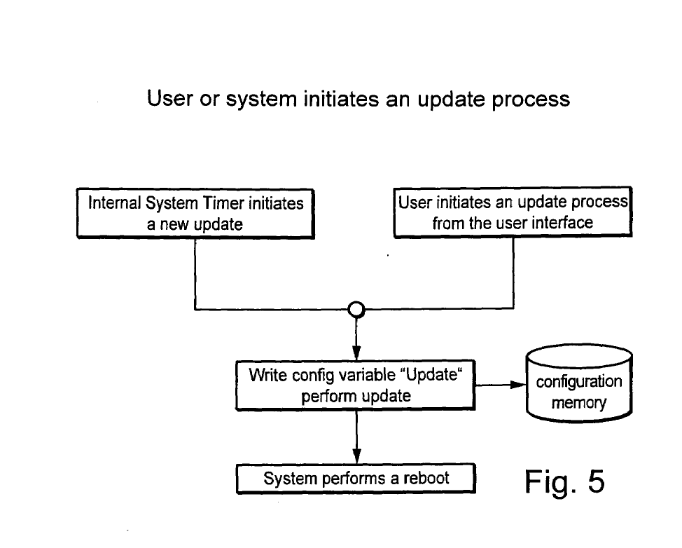

FIG. 5 flow diagram for initiating the update procedure;

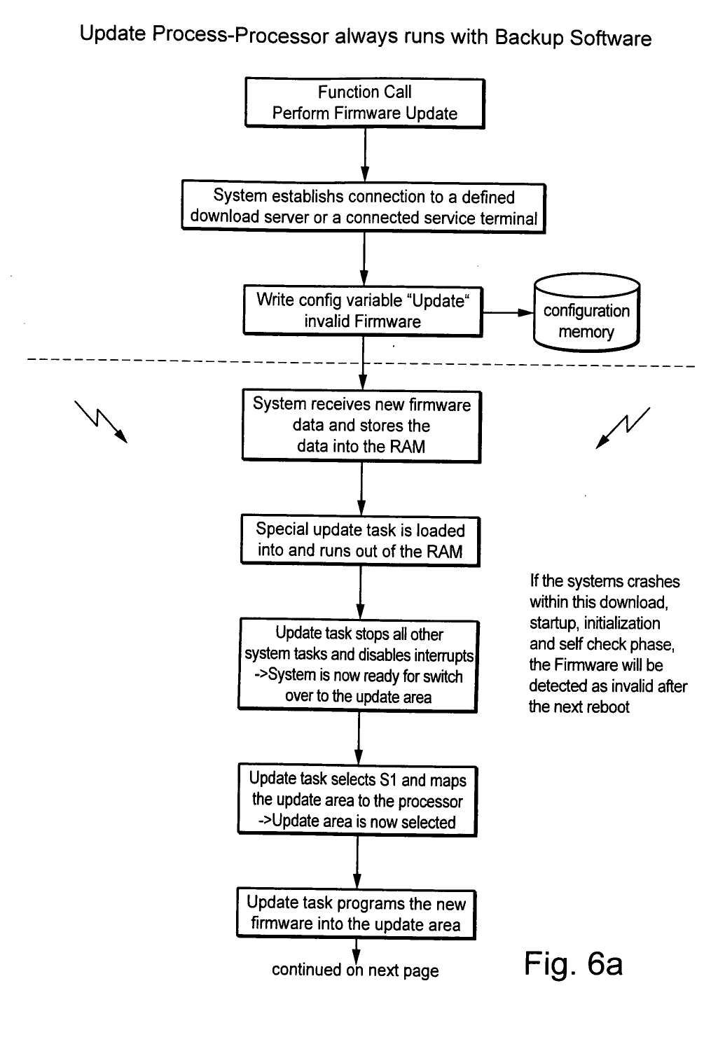

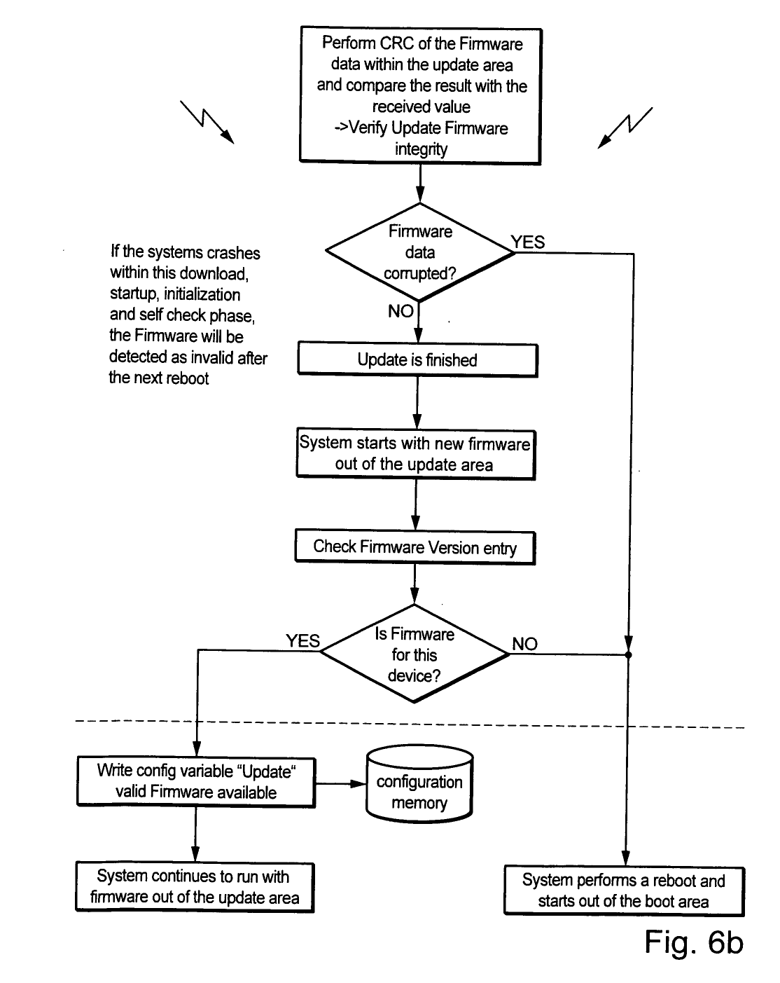

FIG. 6 flow diagram for the function invocation “perform update”.

FIG. 1 details a communication network KN of automation technology. Connected to data bus D1 are a plurality of computer units, workstations WS1, WS2. These computer units serve as superordinated units (control systems or control units) for, among other things, process visualization, process monitoring and for engineering, as well as for servicing and monitoring field devices. Data bus D1 works e.g. according to the Profibus DP-standard or according to the HSE (high speed Ethernet) standard of Foundation Fieldbus.

Data bus D1 is connected with a fieldbus segment SM1 via a gateway G1, also referred to as a linking device or a segment coupler. Fieldbus segment SM1 is composed of a plurality of devices F1, F2, F3, F4, which are designated in process automation technology, in general, as field devices and which are connected together via a fieldbus FB. Field devices F1, F2, F3, F4 can be both sensors or actuators. Fieldbus FB works according to one of the known fieldbus standards, Profibus, Foundation Fieldbus or HART.

If, instead of the gateway G1, the Fieldgate product of the firm, Endress+Hauser, is used, then e.g. a connection of the field devices F1, F2, F3, F4 with the superordinated units W1, W2 via the Internet is possible.

FIG. 2 details a field device of the invention, e.g. field device F1, at the level of a block diagram. A microprocessor μP, serving as a measured value processor, is connected via an analog-digital converter A/D and an amplifier A with a measuring transducer MT, which registers a process variable (e.g. pressure, flow or fill level). Microprocessor μP is also connected with a number of memories. Memory VM serves as temporary (volatile), working memory RAM. In memory PM, i.e. the program memory, software or software-components are stored, which are executed in the microprocessor μP.

Program memory PM has a switchable input S1, via which different memory areas can be selected by the microprocessor μP via a port output PO.

In a non-volatile, writable data memory NVM, e.g. EEPROM-memory, parameter values (e.g. calibration data, etc.) are stored.

The software code running in the microprocessor μP, the program to be executed, defines, among other things, the application-related functionalities of the field device (measured value calculation, envelope curve evaluation, linearizing of measured values, diagnostic tasks).

Additionally, microprocessor μP is connected with a display/service unit D/S (e.g. LCD-display with a plurality of push-buttons).

For communication with the fieldbus segment SM1, the microprocessor μP is connected via a communication-controller COM with a fieldbus interface FBI. A power supply PS delivers the required energy for the individual electronic components of the field device F1. It can be fed from the fieldbus FB or from a separate energy source. Supply lines for power supply of individual components in the field device are not shown, in order not to burden the drawing with excess lines.

A monitoring unit (watchdog) WD, which is likewise connected with the microprocessor μP, monitors the functioning of the microprocessor μP. If a program interruption should occur due to a system error, then the monitoring unit initiates a system boot.

FIG. 3 provides an enlarged view of the program memory PM with the two memory areas, boot-area BA and update-area UA. The program memory PM has a memory capacity of 1024 kB. Its address space is exactly twice as large as that which can be managed by the microprocessor μP. Via the switchable input S1, the two memory areas BA, UA can be selected by the microprocessor μP and fully addressed.

FIG. 4 shows a flow diagram of system behavior following a system boot in the case of a field device, e.g. field device F1.

The system is booted from the first memory area (boot area) with the basic program, which provides a first operating system and first functionalities of the field device.

Then the system variable UPDATE is read, as stored in the memory NVM, the configuration memory.

If the system variable UPDATE contains the value “perform update”, then a function “perform firmware update” is invoked.

First, the system variable UPDATE is set to “invalid firmware”.

Then, via the communication network KN, a connection is established to a superordinated unit, a server or a host computer, e.g. WS1, and transfer of the new software code is requested. The new software code is thereupon transferred into the field device F1 and stored in the second memory area UA (update area).

For performing the equipping, or update procedure, a special update program is loaded into the RAM memory VM and executed. This program switches the port output PO in such a manner that only the update area UA of the program memory PM can be used for storage.

The microprocessor accesses, thus, thereafter, only the update area UA, without noticing this as regards address. The new software code is transferred serially into the update-area UA of the program memory PM and stored there.

Following transfer, the new software code is checked for bit error with the help of a CRC test.

In the case of a bit error (at least one), a renewed system boot is performed with the basic program from the first memory area BA. This basic program must have at least the communication stack for establishing communication to a superordinated unit and must enable storage of the new software code.

Should there be no bit errors, the new software code from the second memory area UA is executed. The new software code can include both a new operating system as well as also an improved device software. Since, now, with the new software code, a valid firmware is available in the field device, the system variable UPDATE is set to the value “valid firmware”.

If the system variable UPDATE does not have the value “perform update”, but, instead, the value “valid firmware”, a test of the software in the second memory area for bit errors occurs, likewise with a CRC-test.

When no bit errors are found, the software of the second memory area is executed. In the other case, the system variable UPDATE is written with the value “invalid firmware”, and the device runs then with the basic program from the first memory area.

FIG. 5 shows a flow diagram for initiating the update. procedure. Such can be initiated by the system itself via a timer or it can be initiated externally. In such case, the system variable UPDATE is written with the value “perform update” and the device executes a system boot with the basic program, i.e. a reboot procedure is started.

FIG. 6 shows a flow diagram for the function invocation “perform firmware update”. Because of size, the diagram is divided into two portions, FIGS. 6a and 6b. The individual method steps have already essentially been described above.

Supplementally, there is also a review of whether the new software, i.e. the firmware, is really intended for the relevant device. For this, the entry, Firmware Version, is checked. When the new software is not intended, or suitable, for the device, naturally, a renewed system boot must occur using the basic program.

The new software can also be transferred piecewise, i.e. in smaller packets, into the device. In such case, an Update-Task repeatedly switches the memory area in the program memory PM between the first and second memory areas.

Various advantages of the method will now be revisited.

A complicated Pre-Power Fail recognition is not needed. Also, when disturbances occur during the update-procedure, e.g. in the storing of the new software, the device still remains able to function.

Even in the case of program errors in the new software that can not be detected via a CRC-test, the system can not fall into an undefined state leading to total shutdown in which the device remains “dead” for ever. Via the watchdog-unit WD, a system boot can be executed with the basic program, which is always available.

The device can also self-sufficiently initiate an update-procedure.

By setting the system variable UPDATE, the device can be started anew from a remote location or on-site.

The method leads to a very robust, microprocessor-controlled device, which always has run-capable software, the basic program. Possible disturbances in the update procedure do not mean that a service technician has to go looking for the device, in order to remove the error on-site.

In the case of error during transfer of the new software code, automatically, a corresponding report is transmitted to the sender, i.e. the superordinated unit.

By the special dividing of the program memory PM and with the selection of the active memory area via the switchable input S1, a resource-saving update-procedure is possible.

The method of the invention is, due to its simplicity and robustness, suited not only for field devices of automation technology but also, quite generally, for microprocessor-controlled devices, which are generally referred to as “embedded systems”.

1-6. (canceled)

7. A method for equipping a microprocessor-controlled device with new software code via a communication network, wherein the device has a non-volatile program memory, with two memory areas, a first memory area and a second memory area, wherein the first memory area (boot sector) is provided for a basic program, which provides a first operating system and first functionalities of the device, and the second memory area (update sector) is provided for the software code to be transferred, and the first memory area is protected by hardware means against over-writing, comprising the following method steps:
system booting with the basic program from the first memory region; reading a system variable UPDATE;
if the system variable UPDATE has the value “perform update”, invoking a function “perform firmware update” with sub-steps as follows: writing to the system variable UPDATE the value “invalid firmware”; establishing a connection to a superordinated unit and transferring new software code into the device; storing the new software code in the second memory area; testing the new software code for bit error; in case a bit error occurs, re-booting the system according to step A); in case no bit error occurs, executing the new software code from the second memory area; writing to the system variable UPDATE the value “valid firmware”;
if the system variable UPDATE has the value “valid firmware”, testing the software in a second memory area for bit error;
if no bit errors are present, executing the software of the second memory area; and
if bit error is present, writing to the system variable UPDATE the value “invalid firmware” and executing the software in the first memory area.

8. The method as claimed in claim 7, wherein:
in case a bit error is present, a report is transmitted via the communication network to the sender of the software code.

9. The method as claimed in claim 7, wherein:
the non-volatile program memory is activated by a microprocessor and the program memory makes available a greater address space than can be managed by the microprocessor.

10. The method as claimed in claim 9, wherein:
the address space is twice as large as the address space manageable by the microprocessor.

11. The method as claimed in claim 10, wherein:
the non-volatile program memory has a memory capacity of 1024 kB.

12. The method as claimed in claim 7, wherein:
the microprocessor has a port output PO, which is connected with a switchable input S1 of the program memory PM serving for selecting one of the two memory regions or the other.
